(19) United States
(12) Patent Application Publication
(10) Pub. No.: US 2009/0010613 A1
(43) Pub. Date: Jan. 8, 2009

(54) RECORDING DEVICE

(75) Inventors: Takeshi MURAKAMI, Machida (JP); Masao Gunji, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/234,379

(22) Filed: Sep. 19, 2008

Related U.S. Application Data
(63) Continuation of application No. PCT/JP2006/305603, filed on Mar. 20, 2006.

(51) Int. Cl. H04N 5/91

(52) U.S. Cl. 386/83; 386/E05.003

(57) ABSTRACT

In order to provide a recording device capable of recording a program desired by the user from among programs relating to a specified keyword, the recording device comprises recording program extraction unit to extract a program relating to a keyword, serial program extraction unit to extract a serial program, played serial program extraction unit to extract a serial program including at least one program that has been played, and timer recording program specification unit to add the serial program extracted by the played serial program extraction unit to timer recording information.

### CROSS REFERENCE TO RELATED APPLICATION

This application is a continuation of PCT application of PCT/JP2006/305603, which was filed on Mar. 20, 2006.

### BACKGROUND OF THE INVENTION

1. Field of the Invention

The present invention relates to a recording device for automatically recording programs relating to desired keywords.

2. Description of the Related Art

In recent years, services have been provided in which program schedules during a particular term are provided by using text broadcasting or networks such as the Internet or the like. Also, automatic recording devices are provided, by which programs completely or partially corresponding to an arbitrary keyword specified by users are automatically recorded by utilizing this service.

However, it often occurs that programs that are not desired by the user are also recorded by this automatic recording method based on keywords. Accordingly, a greater amount of space on HDDs (hard disk drives) or video tapes than necessary is used, which is problematic.

Also, because HDDs or video tapes are used more than necessary, the programs the user desires to be recorded sometimes cannot be recorded, which is problematic.

Patent Document 1 discloses an image device that facilitates operation by comprising an automatic operation function and an interface for causing the user to select programs from among recommended programs to which priority orders are given for selecting broadcasting stations or recording programs.

Patent Document 2 discloses a timer recording device having, in order to save labor for recording serial programs, a function of extracting, from scheduled program information, programs whose content has continuity with the programs that were recorded or for which a recording timer was set.

Patent Document 3 discloses a program receiver device that guesses the preference of the user on the basis of the programs recorded by the user, and extracts the programs that match the user's preference in order to suggest these programs as recommended programs.

Patent Document 4 discloses a recording device that determines whether or not recorded programs have been played.

Patent Document 5 discloses a recording device having means for determining the play status, and deleting a recorded program when the recorded program is determined to not be of interest to the user.

### Patent Document 1:

### Japanese Patent Application Publication No. 07-135621

### Patent Document 2:

### Japanese Patent Application Publication No. 11-252494

### Patent Document 3:

### Japanese Patent Application Publication No. 2000-341599

### Patent Document 4:

### Japanese Patent Application Publication No. 2004-88634

### Patent Document 5:

### Japanese Patent Application Publication No. 2001-257986

### SUMMARY OF THE INVENTION

The present invention is achieved in view of the above problems, and it is an object of the present invention to provide a recording device that can record only a program desired by the user from among programs relating to a specified keyword.

In order to solve the above problems, a recording device according to the present invention comprises:

a recording program extraction unit to extract a program relating to a desired keyword;

a serial program extraction unit to extract, from among programs extracted by the recording program extraction unit, a serial program including a plurality of programs to be broadcast or distributed over a plurality of times and also including at least a predetermined number of programs broadcast or distributed and recorded in the past;

a played serial program extraction unit to extract a serial program including at least one program that has been played among the recorded programs; and

a timer recording program specification unit to add the serial program extracted by the played serial program extraction unit to timer recording information for specifying programs to be timer recorded.

According to the present invention, the recording device according to the present invention extracts a serial program including at least a predetermined number of programs broadcast or distributed and recorded in the past, and also including at least one program that has been played (a serial program having a play history), and adds the serial program to the timer recording information.

As a result of this, it is possible that when, for example, there is a play history for a serial program that has been recorded, the serial program is added to the timer recording information in order to continue the timer recording of that serial program, and when there is no play history for a serial program that has already been recorded, the serial program can be deleted from the timer recording information in order to stop the future timer recording of that serial program.

In other words, by extracting a program to be timer recorded on the basis of the play status of the recorded serial program and generating timer recording information, an effect in which only a serial program desired by the user from among programs relating to a specified keyword can be recorded is achieved.

As described above, according to the present invention, it is possible to provide a recording device that can record only a program desired by the user from among programs relating to a specified keyword.

### BRIEF DESCRIPTION OF THE DRAWINGS

FIG. 1 schematically shows a recording device according to an example of the present invention;

FIG. 2 shows an example of a configuration view of the recording device according to an example of the present invention;

FIG. 3 shows an example of a timer recording table according to the present example;

FIG. 4 shows an example of a recorded program list according to the present example;

FIG. 5 shows a flowchart for schematically showing a process of generating the timer recording table according to the present example;

FIG. 6 shows a flowchart for showing a timer recording process of the recording device according to the present example;

FIG. 7 shows a flowchart for showing a play process of the recording device according to the present example; and

FIG. 8 shows, in detail, a flowchart for the process of generating the timer recording table according to the present example.

### DESCRIPTION OF THE PREFERRED EMBODIMENTS

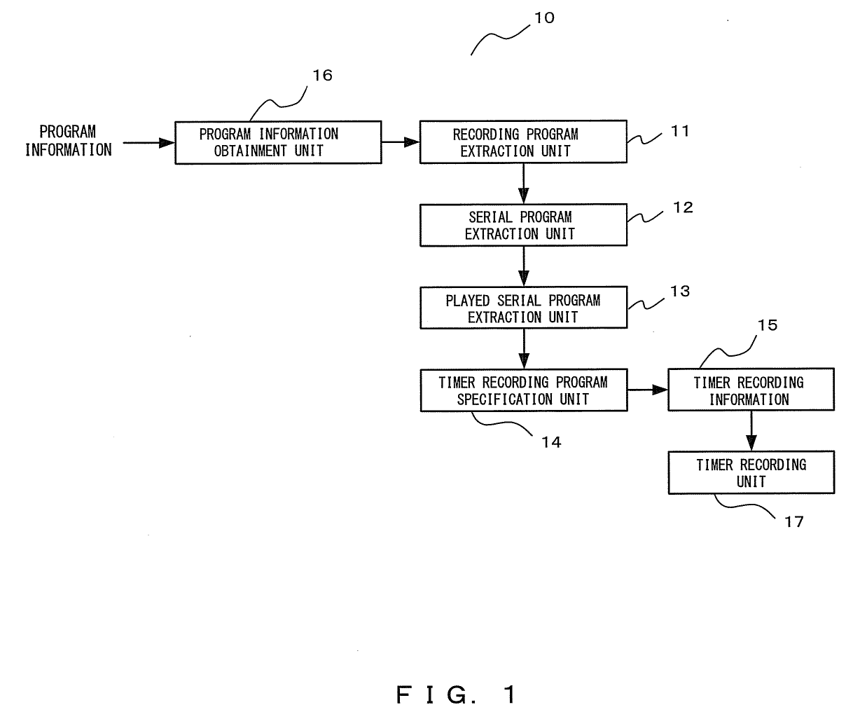

The examples of the present invention will be explained by referring to FIGS. 1 through 8.

FIG. 1 schematically shows a recording device according to an example of the present invention.

A recording device 10 in FIG. 1 includes at least recording program extraction unit 11 for extracting a program relating to a keyword, serial program extraction unit 12 for extracting a serial program, a played serial program extraction unit 13 for extracting a serial program including at least one program that has been played, and timer recording program specification unit 14 for adding to timer recording information 15 the serial program extracted by the played serial program extraction unit 13.

The recording program extraction unit 11 extracts, from program information or the like, the programs relating to the keywords specified by the user. “Program relating to keyword” is, for example, a program whose tile corresponds to a keyword completely or partially. However, this example is not intended to limit the scope of the present invention, and it is sufficient if a program relating to a keyword can be extracted using a method appropriate to program information (data format).

The serial program extraction unit 12 extracts, from among the programs extracted by the recording program extraction unit 11, a serial program including a plurality of programs to be broadcast or distributed over a plurality of times and also including at least a predetermined number of programs broadcast or distributed and recorded in the past.

“Serial program” used herein is a program to be broadcast or distributed over a plurality of times, such as a drama series broadcast on a particular day every week, or a program broadcast at the same hour from Monday through Friday.

“Serial program including at least a predetermined number of programs broadcast or distributed and recorded” is, for example, a program that consists of twelve broadcasts and whose first through third broadcasts have already been recorded when the predetermined number is assumed to be three (however, this series of recorded does not have to start with the first broadcast).

The played serial program extraction unit 13 extracts, from among the recorded programs, a serial program including at least one program that has already been recorded, and the timer recording program specification unit 14 adds, to the timer recording information 15 specifying programs to be timer recorded, the serial program extracted by the played serial program extraction unit 13.

For example, in the above example, when none of the recorded first through third programs of the serial program has been played (there is not a play history), that serial program is removed from the timer recording information 15 or that serial program is not added to the timer recording information 15. When at least one of the recorded first through third programs of the serial program has been played, that serial program is added to the timer recording information 15.

Additionally, “when at least one of the recorded programs has been played” is not intended to limit the scope of the present invention and, for example, it is also possible to employ a configuration in which when at least two of the recorded programs of a serial program have not been played, the serial program is removed from the timer recording information 15.

Also, the recording device 10 according to the present example further comprises program information obtainment unit 16 for obtaining program information, and timer recording unit 17 for recording programs in accordance with the timer recording information 15.

The program information obtainment unit 16 obtains program information on programs scheduled to be broadcast or distributed during a prescribed term, and outputs the information to the recording program extraction unit 11. The program information is obtained from, for example, TV broadcasting, the Internet, or the like. Program information is information on the programs scheduled to be broadcast or distributed in a prescribed term. Also, “distributed” means being distributed via, for example, networks such as the Internet, dedicated cables, and the like.

The timer recording unit 17 records the programs in accordance with the timer recording information 15, and generates recorded program information of a recorded serial program including at least a title, a serial number, and a view history representing whether or not the serial program has been played.

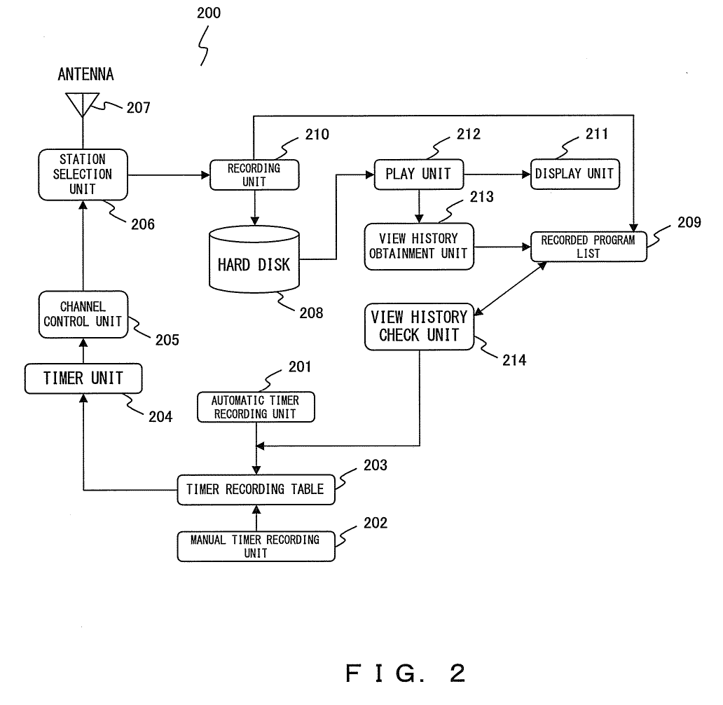

FIG. 2 shows an example of a configuration view of a recording device 200 according to an example of the present invention.

The recording device 200 shown in FIG. 2 comprises an automatic timer recording unit 201 for automatically setting a recording timer in accordance with a keyword, a manual timer recording unit 202 for accepting the manual setting of the recording timer, a timer unit 204 for monitoring times specified on a timer recording table 203 generated by the automatic timer recording unit 201 and the manual timer recording unit 202, a channel control unit 205 for performing control so that the specified broadcasting stations are selected at a time specified in the timer recording table 203, a station selection unit 206 for selecting a broadcasting station specified by the channel control unit 205, an antenna 207 for receiving TV programs and Electronic Program Guides (EPG) transmitted from broadcasting stations, a recoding unit 210 for storing the received programs in a hard disk 208 and for adding the stored programs to a recorded program list 209, a play unit 212 for displaying on a display unit 211 the programs stored in the hard disk 208 (hereinafter referred to as “recorded program”), a view history obtainment unit 213 for obtaining a view history of the programs played by the play unit 212 and adding the history to the recorded program list 209, and a view history check unit 214 for reporting to the automatic timer recording unit 201 the play status of the recorded programs by checking the view histories in the recorded program list 209.

The automatic timer recording unit 201 obtains keywords input by the user through the input unit (not shown). Then, the automatic timer recording unit 201 extracts a list of the programs relating to the keywords from periodically received electronic program guides.

Also, the view history check unit 214 checks the view history of an extracted serial program including a predetermined number of recorded programs.

Then, if the serial program does not have a view history, the program is removed from the timer recording table 203 or it is not added to the timer recording table 203.

The manual timer recording unit 202 adds to the timer recording table 203 the programs input (specified) by the user through input unit (not shown).

Also, in the present example, TV programs and electronic program guides are received through the antenna 207; however, programs distributed via networks such as the Internet or dedicated cables may be obtained by using, for example, a network connection device instead of the antenna 207.

In the above described configurations, the program information obtainment unit 16 can be realized by using the automatic timer recording unit 201, the timer unit 204, the channel control unit 205, the station selection unit 206, and the antenna 207.

Also, the recording program extraction unit 11, the serial program extraction unit 12, the played serial program extraction unit 13, and the timer recording program specification unit 14 can be realized by the automatic timer recording unit 201, and also by, if necessary, the timer recording table 203, the recorded program list 209, and the view history check unit 214.

Also, the timer recording information 15 can be realized by the timer recording table 203, and the timer recording unit 17 can be realized by the timer recording table 203, the timer unit 204, the channel control unit 205, the station selection unit 206, the antenna 207, the hard disk 208, and the recoding unit 210.

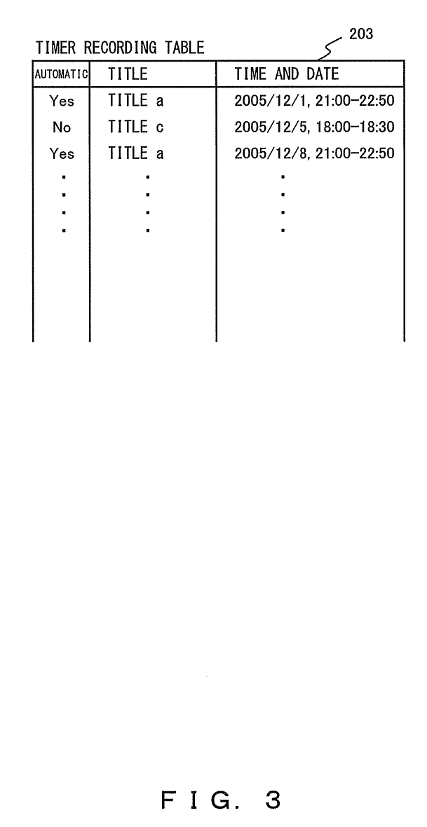

FIG. 3 shows an example of the timer recording table 203 according to the present example.

The timer recording table 203 shown in FIG. 3 has the items “Automatic”, “Title”, and “Time and date”.

The item “Automatic” represents whether or not the corresponding title is a title specified by the automatic timer recording unit 201. In other words, when this item shows “Yes”, it shows the program title specified by the automatic timer recording unit 201. When this item shows “No”, it shows a program title specified by the manual timer recording unit 202. “Title” represents the titles of the programs to be timer recorded. “Time and date” represents the scheduled time and date of broadcasting the program.

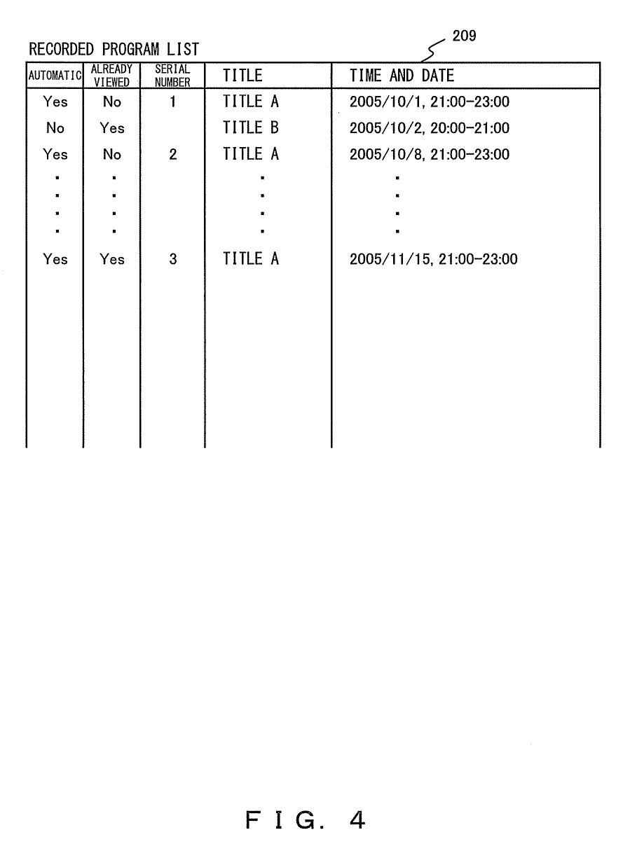

FIG. 4 shows an example of the recorded program list 209 according to the present example.

The recorded program list 209 shown in FIG. 4 has the items “Automatic”, “Already viewed”, “Serial number”, “Title”, and “Time and date”.

The item “Automatic” represents whether or not the program is a program specified by the automatic timer recording unit 201. When this item shows “Yes”, this means that the program specified by the automatic timer recording unit 201 has been recorded. When this item represents “No”, this means that the program specified by the manual timer recording unit 202 has been recorded.

“Already viewed” represents whether or not the corresponding program has been played; in other words, it is a view history representing whether or not the program has been viewed by the user. “Yes” means that the program has been viewed. “No” means that the program has not been viewed.

“Serial number” represents the number of recorded programs in a serial program. In the example of the recorded program list 209 in FIG. 4, it is shown that the content for the first broadcast (broadcast from 21:00 through 23:00 on Oct. 1, 2005), the content for the second broadcast (broadcast from 21:00 through 23:00 on Oct. 8, 2005), and the content for the third broadcast (broadcast from 21:00 through 23:00 on Oct. 15, 2005) in a serial program (title A) that consists of content for twelve broadcasts are recorded. Accordingly, the serial numbers are “1”, “2”, and “3” respectively. Additionally, the serial numbers are assigned starting from the broadcast content that was recorded first, and thus even when the content for the second through fourth broadcasts is recorded, the serial numbers are “1”, “2”, and “3” respectively.

“Title” represents the titles of programs recorded by the recoding unit 210, and “Time and date” represents the time and date of recording of a program.

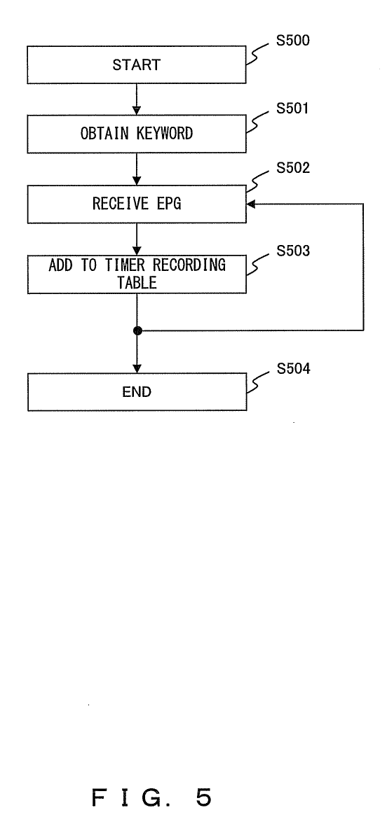

Hereinafter, the process of recording device 200 according to the present example is schematically shown in FIGS. 5 through 7.

FIG. 5 shows a flowchart for schematically showing a process of generating the timer recording table 203 according to the present example.

When the user starts setting of the automatic recording (S500), the recording device 200 causes the process to proceed to step S501.

In step S501, the automatic timer recording unit 201 obtains the keywords input by the user. Then, the process proceeds to step S502. Further, in step S502, the automatic timer recording unit 201 instructs the channel control unit 205 to receive EPGs.

The EPG used herein is information relating to the programs scheduled to be broadcast during a week starting from a prescribed time and date, and is text data including at least titles and broadcasting times and dates of the respective programs. However, the EPG does not have to be text data, and can be based on the XML format or the HTML format.

When receiving the EPG, the automatic timer recording unit 201 causes the process to proceed to step S503. Then, the automatic timer recording unit 201 obtains from the EPG programs having titles completely or partially corresponding to the keywords obtained in step S501, and adds these programs to the timer recording table 203. When there is no timer recording table 203, the automatic timer recording unit 201 generates the timer recording table 203 and adds the programs to the generated timer recording table 203.

When this step is performed, the automatic timer recording unit 201 identifies serial programs from among the programs obtained from the EPG by referring to the recorded program list 209. Then, the view histories for the content for the past three broadcasts counting from the latest recorded broadcasted content in the respective serial programs is confirmed, and if none of them has been viewed, the corresponding serial program is removed from the timer recording table 203.

The processes in the above steps S502 and S503 are periodically (once a week, for example) executed until the user stops using automatic recording based on keywords.

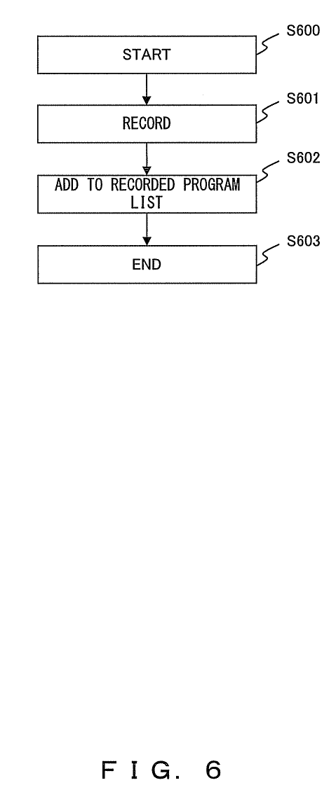

FIG. 6 shows a flowchart for showing a timer recording process of the recording device 200 according to the present example.

When the timer unit 204 detects the time and date specified in the timer recording table 203, the automatic timer recording unit 201 starts timer recording (S600).

In step S601, the automatic timer recording unit 201 causes the channel control unit 205 to select the broadcasting station specified in the timer recording table 203. Then, the automatic timer recording unit 201 causes the recoding unit 210 to record the program received through the antenna 207.

When the recording is completed, the recoding unit 210 causes the process to proceed to step S602, and adds the recorded program to the recorded program list 209. When there is no recorded program list 209, the recorded program is added after the recorded program list 209 is generated.

When this step is performed, the recoding unit 210 refers to the timer recording table 203, obtains the information “Automatic”, “Title”, and “Time and date” of the program from the timer recording table 203, and adds them to the recorded program list 209.

Further, the recoding unit 210 refers to the recorded program list 209, and searches for programs having the same title as that of the recorded program. When the recorded program list 209 has a title that is the same as that of the recorded program, a value obtained by incrementing the latest serial number by one is stored as the “serial number” of the recorded program.

When the addition to the recorded program list 209 is completed, the recording device 200 causes the process to proceed to step S603, and the timer recording process is terminated.

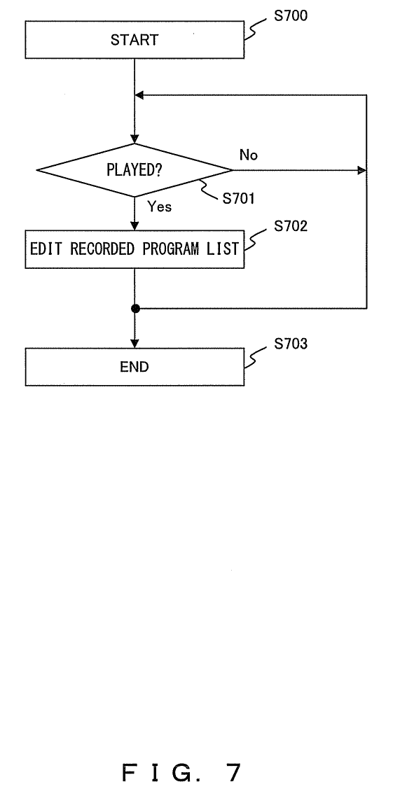

FIG. 7 shows a flowchart showing a play process of the recording device 200 according to the present example.

When the user activates the playing of a recorded program (S700), the recording device 200 causes the process to proceed to step S701.

In step S701, the play unit 212 reports the played program to the view history obtainment unit 213, and the process proceeds to step S702. Then, in step S702, the view history obtainment unit 213 changes the “Already viewed” item of the reported recorded program into “Yes”, and adds a view history.

The addition of a view history to the recorded program list 209 may be executed after the playing of the corresponding recorded program is terminated.

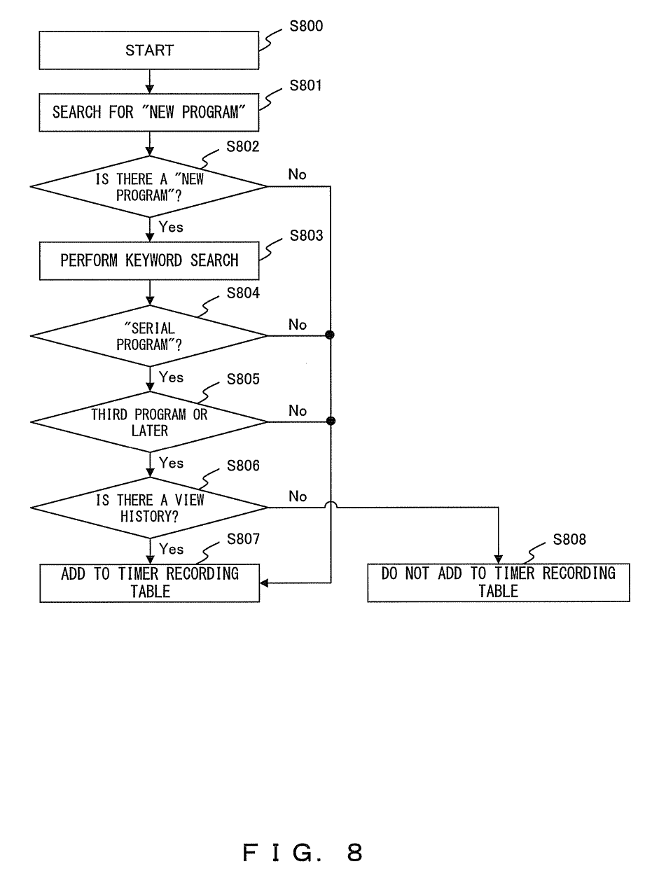

FIG. 8 shows a flowchart for the process of generating the timer recording table according to the present example.

When an EPG is received in step S502 in FIG. 5, the automatic timer recording unit 201 causes the process to proceed to step S800, and starts the timer recording table generation process.

In step S801, the automatic timer recording unit 201 checks whether or not the respective program titles in the EPG include a keyword having the meaning of a new program (in the present example, “new program” is used as the keyword).

When a program whose title includes a “new program” is detected in step S802, the automatic timer recording unit 201 causes the process to proceed to step S807. Then, the program detected in step S801 is added to the timer recording table 203. Also, when a program whose title does not include “new program” is not detected, the process proceeds to step S803.

In step S803, the automatic timer recording unit 201 refers to the EPG, and detects a program whose title completely or partially corresponds to the keyword (an arbitrary keyword specified by the user) obtained in step S501 in FIG. 5. When a title that completely or partially corresponds to the keyword is not detected, the timer recording table generation process is terminated (this process is not shown in the figure).

In step S804, the automatic timer recording unit 201 checks whether or not the program detected in step S803 is a “serial program”. For example, the automatic timer recording unit 201 refers to the recorded program list 209, and searches for a title that completely or partially corresponds to the title of the program detected in step S803. When there is at least one corresponding title, the program is determined to be a “serial program”.

When the program detected in step S803 is not a “serial program”, the automatic timer recording unit 201 causes the process to proceed to step S807. Then, the program is added to the timer recording table 203.

When the program detected in step S803 is a “serial program”, the automatic timer recording unit 201 causes the process to proceed to step S805.

In step S805, the automatic timer recording unit 201 refers to the recorded program list 209, and obtains the serial number of the corresponding program having the time and date closest to the present time and date. When the serial number is smaller than three, the automatic timer recording unit 201 determines that the number of recorded programs in the serial program is less than three, and causes the process to proceed to step S807.

When the serial number is greater than three, the automatic timer recording unit 201 determines that the number of recorded programs in the corresponding serial program is equal to or more than three, and causes the process to proceed to step S806.

In step S806, the automatic timer recording unit 201 refers to the recorded program list 209. Then, the automatic timer recording unit 201 refers to the view history of the corresponding serial program, and determines whether or not there is a view history. When there is a view history, the process proceeds to step S807, and the corresponding serial program is added to the timer recording table 203. When there is not a view history, the process proceeds to step S808, and the addition of the corresponding serial program to the timer recording table 203 is stopped.

In the process of step S805 and S806 explained above, the serial program including at least three recorded programs is extracted and the view history is confirmed. However, the scope of the present invention is not limited to this. It is possible to extract, as necessary, a serial program including, for example, at least five programs that were recorded.

Under the condition that none of the programs that are already recorded in step S806 has a view history, the addition of the program to the timer recording table 203 is stopped. However, the scope of the present invention is not limited to this condition. For example, it is possible to stop the addition to the timer recording table 203 when at least two programs that have already been recorded do not have a view history.

As described above, the recording device 200 according to the present example extracts from the EPG the programs that completely or partially correspond to the keywords. Then, the extracted programs are added to the timer recording table 203, not including the serial programs that include at least three recorded programs and that do not have a view history, and accordingly it is possible to record only the programs that are desired by the user while avoiding the automatic recording of serial programs that the user will not view, i.e., serial programs that are not desired by the user.

Also, as a result of this, it is possible to avoid unnecessary consumption of HDD and video tapes.

What is claimed is:

1. A recording device, comprising:
a recording program extraction unit to extract a program relating to a desired keyword;
a serial program extraction unit to extract, from among programs extracted by the recording program extraction unit, a serial program including a plurality of programs to be broadcast or distributed over a plurality of times and also including at least a predetermined number of programs broadcast or distributed and recorded in the past;
a played serial program extraction unit to extract a serial program including at least one program that has been played among the recorded programs; and
a timer recording program specification unit to add the serial program extracted by the played serial program extraction unit to timer recording information for specifying programs to be timer recorded.

2. The recording device according to claim 1, further comprising:
a program information obtainment unit to obtain program information relating to a program scheduled to be broadcast or distributed in a prescribed term, wherein:
the recording program extraction unit extracts a program relating to the keyword from the program information.

3. The recording device according to claim 2, wherein:
the program relating to the keyword is a program whose title in the program information completely or partially corresponds to the keyword.

4. The recording device according to claim 1, further comprising:
a timer recording unit to record a program in accordance with the timer recording information, and for generating recorded program information including at least a title of the serial program recorded, a serial number assigned as an order of recording of the serial program, and a view history representing whether or not the serial program has been played.

5. A recording method, comprising:
a recording program extraction step of extracting a program relating to a desired keyword;
a serial program extraction step of extracting, from among programs extracted in the recording program extraction step, a serial program including a plurality of programs to be broadcast or distributed over a plurality of times and also including at least a predetermined number of programs broadcast or distributed and recorded in the past;
a played serial program extraction step of extracting a serial program including at least one program that has been played among the recorded programs; and
a timer recording program specification step of adding the serial program extracted in the played serial program extraction step to timer recording information for specifying programs to be timer recorded.

6. The recording method according to claim 5, further comprising:
a program information obtainment step of obtaining program information relating to a program scheduled to be broadcast or distributed in a prescribed term, wherein:
a program relating to the keyword is extracted from the program information in the recording program extraction step.

7. The recording method according to claim 6, wherein:
the program relating to the keyword is a program whose title in the program information completely or partially corresponds to the keyword.

8. The recording method according to claim 5, further comprising:
a timer recording step of recording a program in accordance with the timer recording information, and of generating recorded program information including at least a title of the serial program recorded, a serial number assigned as an order of recording of the serial program, and a view history representing whether or not the serial program has been played.

9. A recording medium for a program causing a recording computer to execute:
a recording program extraction step of extracting a program relating to a desired keyword;
a serial program extraction step of extracting, from among programs extracted in the recording program extraction step, a serial program including a plurality of programs to be broadcast or distributed a plurality of times and also including at least a predetermined number of programs broadcast or distributed and recorded in the past;
a played serial program extraction step of extracting a serial program including at least one program that has been played among the recorded programs; and
a timer recording program specification step of adding the serial program extracted in the played serial program extraction step to timer recording information for specifying programs to be timer recorded.

10. The recording medium for a program according to claim 9, further causing the recording computer to execute:
a program information obtainment step of obtaining program information relating to a program scheduled to be broadcast or distributed in a prescribed term, wherein:
a program relating to the keyword is extracted from the program information in the recording program extraction step.

11. The recording medium for a program according to claim 10, wherein:
the program relating to the keyword is a program whose title in the program information completely or partially corresponds to the keyword.

12. The recording medium for a program according to claim 9, further causing the recording computer to execute:
a timer recording step of recording a program in accordance with the timer recording information, and of generating recorded program information including at least a title of the serial program recorded, a serial number assigned as an order of recording of the serial program, and a view history representing whether or not the serial program has been played.
